(19) United States
(12) Patent Application Publication
(10) Pub. No.: US 2024/0280724 A1
(43) Pub. Date: Aug. 22, 2024

(54) SYSTEM AND METHOD FOR MODELING STRESS DISTURBANCES FOR LATERAL WELLBORE DRILLING

(71) Applicant: SAUDI ARABIAN OIL COMPANY, Dhahran (SA)

(72) Inventors: Osman HAMID, Dhahran (SA); Hussain ALBAHRANI, Qatif (SA); Rowa TAWFIQ, Dhahran (SA)

(73) Assignee: SAUDI ARABIAN OIL COMPANY, Dhahran (SA)

(21) Appl. No.: 18/172,908

(22) Filed: Feb. 22, 2023

(51) Int. Cl. G01V 99/00; G06F 30/20

(52) U.S. Cl. CPC G01V 20/00; G06F 30/20; G06F 2119/14

(57) ABSTRACT

In some examples, an initial wellbore model that includes a formation model and main wellbore model can be generated. The initial wellbore model can be simulated to compute stress distributions in the formation model caused during main wellbore model formation. The initial wellbore model can be updated to include a lateral wellbore model to provide an updated wellbore model in response to the simulation of the initial wellbore model. The updated wellbore model can be simulated to compute updated stress distributions in the formation model caused during lateral wellbore model formation using the determined stress distributions.

### FIELD OF THE DISCLOSURE

This disclosure relates generally to wellbore modeling, and more particularly, to a system and method for modeling stress fields in formations in a presence of lateral wellbores.

### BACKGROUND OF THE DISCLOSURE

Directional drilling (or slant drilling) is a practice of drilling non-vertical bores. Lateral wells are non-vertical bores and are a portion of a directional well past a point where a well bore has been intentionally departed from a vertical bore. Lateral is a term applied to either a single branch or individual multiple (multilateral) branches off the vertical wellbore. A well constructed with more than one lateral branching off a main (or mother) wellbore is known as a multilateral well. Drilling multiple laterals that originate from a mother wellbore is a commonly used technique in maximizing reservoir contact. The mother wellbore can be vertical, deviated, or fully horizontal. Lateral wellbores extending from the mother wellbore can be drilled in a semi-parallel direction. Generally, drillers assume since both the mother wellbore and lateral wellbores are drilled in a same formation (e.g., a same type of rock), within a same direction and trajectory, and using same or similar drilling tools, a drilling experience is expected to be almost identical. However, this is not the case because stress fields in a formation (e.g., rock formation) are changed (e.g., disturbed) following drilling of the mother-bore, which in some instances, reduces or inhibits well operations (e.g., efficacy of mud weight, etc.) for drilling one or more lateral wellbores branching off the mother wellbore.

### SUMMARY OF THE DISCLOSURE

Various details of the present disclosure are hereinafter summarized to provide a basic understanding. This summary is not an extensive overview of the disclosure and is neither intended to identify certain elements of the disclosure nor to delineate the scope thereof. Rather, the primary purpose of this summary is to present some concepts of the disclosure in a simplified form prior to the more detailed description that is presented hereinafter.

According to an embodiment, a computer implemented method can include using a processor to generate an initial wellbore model that includes a formation model and main wellbore model, simulate the initial wellbore model to compute stress distributions in the formation model caused during main wellbore model formation, update the initial wellbore model to include a lateral wellbore model to provide an updated wellbore model, and simulate the updated wellbore model to compute updated stress distributions in the formation model caused during lateral wellbore model formation using the determined stress distributions.

In another embodiment, a system can include memory to store machine-readable instructions, and one or more processors to access the memory and execute the machine-readable instructions. The machine-readable instructions can include a stress field assessment engine having a pre-processing component programmed to generate an initial wellbore model that includes a formation model and main wellbore model, a simulator programmed to simulate the initial wellbore model to compute stress distributions in the formation model caused during main wellbore model formation, and a model updating component programmed to update the initial wellbore model to include a lateral wellbore model to provide an updated wellbore model. In certain embodiments, the simulator is further programmed to simulate the updated wellbore model to determine updated stress distributions in the formation model caused during lateral wellbore model formation using the determined stress distributions.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is an example of a stress field assessment engine.

FIG. 2 is an example of a multilateral wellbore.

FIG. 3 is an example of a graph illustrating a concentration or disturbance of stress due to a presence of a main wellbore.

FIG. 4 is an example of mud weight recommendation graphs.

FIG. 5 is an example of a stress field around a main wellbore.

FIG. 6 is an example of a wellbore model representing a mother wellbore in a formation.

FIG. 7 is an example of another wellbore model representing a mother wellbore and a lateral wellbore in a formation.

FIG. 8 is an example of a method for modeling stress disturbances in a formation

FIG. 9 is another example of a method for modeling stress disturbances in a formation.

FIG. 10 depicts an example computing environment that can be used to perform methods according to an aspect of the present disclosure.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments of the present disclosure relate to lateral wellbore stress field modeling and used therefore for adjusting or updating wellbore drilling operations (conditions). Existing modeling techniques for modeling a main wellbore and a lateral wellbore, for example, using finite element analysis (FEA) is known and can be implemented using existing simulation software such as Comsol Multiphysics®. The modeling approach used by existing modeling software introduces both a main wellbore and a lateral wellbore at a same time for stress field assessment. Examples are described herein in which stress field assessment is completed initially using only the main wellbore to compute initial stress fields and a wellbore model is updated to include the lateral wellbore for stress field assessment. The examples described herein for stress field modeling enable a user to more closely represent or mimic actual drilling conditions. The examples presented herein retain the stress distribution from the main wellbore and introduce the lateral wellbore into a structure formation sequentially in a manner that mimics actual drilling operations.

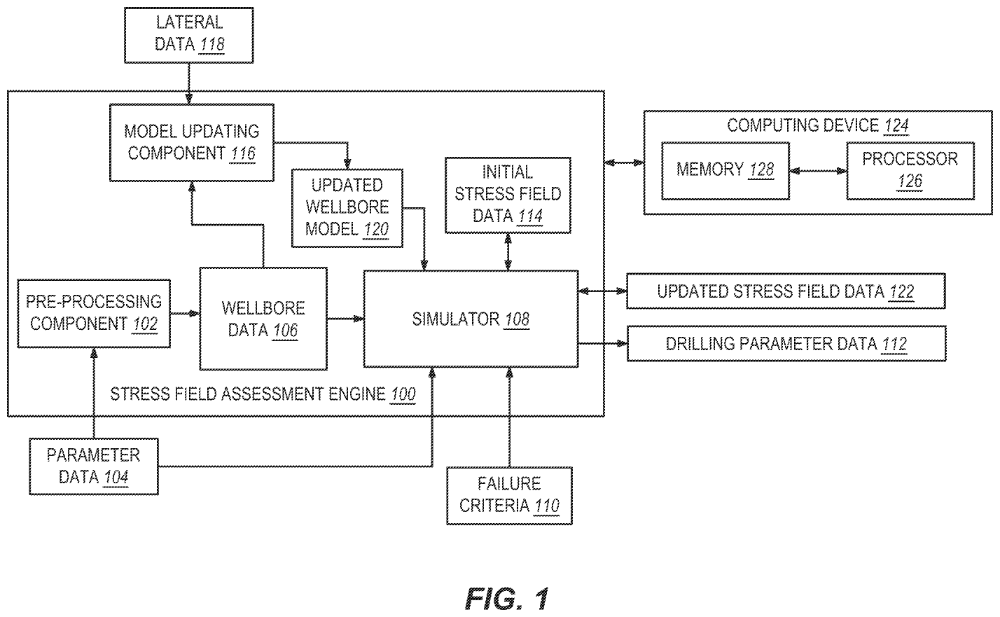

FIG. 1 is an example of a stress field assessment engine 100 that can be used for computing stress disturbances in formations caused by multi-laterals. The stress field assessment engine 100 can be used to evaluate wellbore stability and in some instances, the models generated by the stress field assessment engine 100 can be referred to as wellbore stability models. The term formation as used herein can include any type of earth layer. Thus, while examples are presented herein in which the formation is a rock layer, in other examples, the formation can be a different earth layer, or a combination of earth layers. In some examples, the stress field assessment engine 100 can be embodied as machine readable instructions that can define a software plugin or tool. For example, the stress field assessment engine 100 can be implemented as a part of software used for modeling stress and deformations, or a stand-alone module that can be activated in response to the software, or by a user (e.g., using an input device, as described herein).

The stress field assessment engine 100 includes a pre-processing component 102 that can assign loads, assign heterogeneous material properties for the formation (e.g., a rock formation) and create an initial wellbore model. For example, the pre-processing component 102 can assign the load and the properties based on parameter data 104, which can be user defined, and thus specify load and property requirements for the initial wellbore model. For example, the properties can include geologic (e.g., earth) in-situ stresses acting on a wellbore, a dimension, geometry and a placement of the wellbore within an in-situ stress field, and/or mechanical properties of solid components that form the wellbore. The solid components can include geologic formation rocks, a metal of a casing pipe, and/or a cement sheath attaching a pipe to the formation rock. The mechanical properties can include Young's Modulus, a Poisson's ratio, a yield point, stress-strain curve non-linearity coefficients, plasticity coefficients, and/or strain hardening or softening coefficients. In some instances, the parameter data 104 can define parameters for modeling the main wellbore model. In some examples, the parameter data 104 can be provided as an input file.

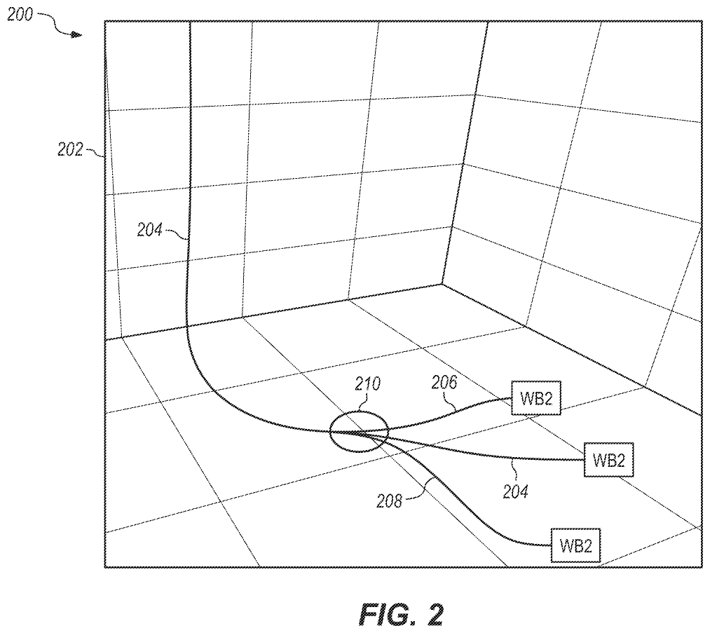

The initial wellbore model can model or represent a main wellbore (e.g., a main wellbore 204, as shown in FIG. 2) in the formation (e.g., a formation 202, as shown in FIG. 2). Thus, the initial wellbore model can be a combination of a main wellbore model (representing a wellbore that would be drilled or formed in a formation) and a formation model (representing the formation in which the wellbore would be drilled). The pre-processing component 102 can output wellbore data 106 that includes the initial wellbore model, and in some instances other data for executing or running a simulation of the initial wellbore model.

In some examples, the initial wellbore model is a mesh model. The initial wellbore model can be implemented as a three-dimensional (3D) model and thus in some instances is a 3D mesh model. For example, the initial wellbore model can be represented using a number of nodes. Each node of the initial wellbore model can represent where vertices and/or edges meet. The pre-processing component 102 can be used to model a geometry and characteristics of the formation and the main wellbore. The pre-processing component 102 in some instances can generate the initial wellbore model using a geometrical modeling engine. In some examples, the pre-processing component 102 can employ geomechanical modeling techniques to model elastic mechanical properties and physical laws of motion (e.g., a mass-spring methodology) to mimic or represent 3D deformation (e.g., rock deformation) in the formation model.

The stress field assessment engine 100 includes a simulator 108 that can simulate stress distributions (or disturbances) that can result or be caused in the formation by the main wellbore based on the wellbore data 106. In some examples, the simulator 108 employs finite element analysis (FEA) techniques to find (e.g., predict) the stress distributions in the formation from drilling or forming the main wellbore therein. For example, the simulator 108 can predict stress changes in the formation model during main wellbore formation simulation. Thus, the simulator 108 can simulate a creation of the main wellbore model in the formation model to represent formation of the main wellbore in the formation. Initially, during the main wellbore formation simulation, the formation model has an undisturbed stress field that is later (during the simulation) modified or changed due forming the lateral wellbore(s) therein. Thus, the simulator 108 can compute a disturbed stress field in the formation. In some examples, the simulator 108 can use or employ plasticity algorithms to model non-linear material behaviors of the formation model during the simulation in computing the disturbed stress field.

For example, the simulator 108 can be configured to use or apply discretization during the simulation using a minimization of a total potential energy according to expression (1):

$$\\ \begin{matrix}u {\int }_{{V}^{{}_{} e}} ( ( {B}^{{}_{} T} ) DB ) d Ω = {\int }_{{V}^{{}_{} e}} {N}^{{}_{} T} Fd Ω - {\int }_{{S}^{{}_{} e}} {N}^{{}_{} T} Td Γ , & ( 1 )\end{matrix}$$

wherein u is a displacement, B is a strain-displacement matrix and B^{T} is a transpose of the strain-displacement matrix, N^{T} is a transpose of a quadratic serendipity shape functions vector (e.g., which can be derived for a 20-nodes isoparametric brick element of the initial wellbore model), D is a consistent tangent matrix (e.g., formulated based on mechanical properties of the formation (e.g., rock formation)), F is a body force, and T is a traction force.

In expression (1), the body force F and traction force T can represent or reflect in-situ stresses and mud weight loading on the main wellbore, and the displacement can indicate a deformation of a certain location within a solid body (e.g., a rock, cement, and/or metal pipe). If a certain fragment of the solid body has exhibited a displacement, this can indicate that this fragment has been deformed. In some examples, numerical simulation methods such as the FEM rely on fragmenting the solid body being examined into discrete elements. These elements can be in different shapes and configurations. In some examples, a 20-node brick element is used to perform fragmentation (or meshing) of a wellbore body. The 20-nodes in each fragmented (or meshed) element can function as a sensor. Through FEM calculations, the displacement can be assessed, and hence the deformation, at each node. The 20-node brick element can be selected because it allows for high resolution of displacement estimations while minimizing a computations time.

The simulator 108 during the simulation can integrate expression (1) at an element volume V^{e} with respect to a volume variable Ω or at an element surface S^{e} with respect to an area variable Γ. A matrix resulting from the integral in the expression to a left is known as the stiffness matrix K^{e}. The stiffness matrix can represent mechanical properties of the formation.

During the simulation, the simulator 108 can determine a strain hardening of the formation model to reflect or represent a plastic behavior of the formation (e.g., the rock formation). For example, the simulator 108 can employ a plastic flow rule for strain hardening to reflect the plastic behavior of the formation, which occurs beyond a yield point. The simulator 108 can determine a total strain (e.g., the strain hardening) for the formation as a function of a poro-elastic strain ε^{e} and a plastic strain ε^{p}. For example, a total strain can be an addition of a linear strain and a plastic strain. The linear strain can be determined from expression (1) by the simulator 108. The displacement u variable in expression (1) can be converted by the simulator 108 into a linear strain. The plastic strain component can then be determined by the simulation using expression (2). Thus, using the plastic flow rule, a flow direction can be perpendicular to a yield surface ψ according to expression (2):

$$\\ \begin{matrix}Δ {ε}_{ij}^{{}_{} p} = λ \frac{\partial ψ ( {σ}_{ij} )}{\partial {σ}_{ij}} , & ( 2 )\end{matrix}$$

wherein εᵢⱼ^{p} is a plastic strain tensor, σᵢⱼ is a stress tensor, and λ is a plastic strain multiplier.

The associative flow rule (e.g., the plastic flow rule) can be applied by the simulator 108 during the simulation by assuming that a plastic potential surface for the formation model is a same as the yield surface ψ. The simulator 108 during the simulation can also assume that the yield surface ψ expands without changing the flow direction. The simulator 108 uses a yield criterion for the yield surface ψ, for example, the Drucker-Prager criterion, where yielding will take place when a deviatoric stress tensor Sᵢⱼ and a mean stress σₘ satisfy the following expression:

$$\\ \begin{matrix}ψ ( {σ}_{ij} ) = \sqrt{\frac{1}{2} {S}_{ij} {S}_{ij}} - {a}_{0} + {a}_{1} {σ}_{m} = 0 , & ( 3 )\end{matrix}$$

wherein constants a₀ and a₁ are determined experimentally as material properties and are used to correlate the Drucker-Prager criterion to a Mohr-Coulomb criterion.

During the simulation, the simulator 108 can calculate the scalar plastic strain ε^{p} from the plastic strain tensor according to the following expression:

$$\\ \begin{matrix}{ε}^{{}_{} p} = \int \sqrt{\frac{2}{3} d {ε}_{ij}^{{}_{} p} d {ε}_{ij}^{{}_{} p}} & ( 4 )\end{matrix}$$

Accordingly, during the simulation, the simulator 108 can compute the stiffness matrix K^{e} and the displacement u by solving expression (1). The simulator 108 can compute or calculate residual forces corresponding to the body force F and traction force T. For example, the simulator 108 can use the residual forces to check for convergence and equilibrium with respect to expression (1) by subtracting a left-hand side from a right-hand side, where the left-hand side is the stiffness matrix K^{e} multiplied by displacement u and the right-hand side is the body force F and traction force T. The simulator 108 can determine that the equilibrium condition of expression (1) is satisfied if the value obtained from the subtraction of these two quantities is equal to zero, and thus expression (1) converges.

In some instances, the simulator 108 uses a tolerance value to check for convergence, for example, in scenarios in which it may be not achievable to satisfy the equilibrium condition of expression (1). The tolerance value can be set to be close zero but not equal to zero. Once the residual forces are calculated by the simulator 108 and the simulator 108 determines that the residual forces are less than the tolerance value, convergence is said to be achieved, otherwise, the residual forces are carried to a next iteration. The above process is repeated for each separate load increment, where the load increments can be defined by the parameter data 104.

In some examples, the simulator 108 can set or define a criterion for formation (e.g., rock and soil) failure. For example, the simulator 108 can use baseline data (e.g., lab test data) to define a failure envelope for the formation model. The failure envelope can be defined at what is known as strength parameters for the formation model, and at certain limits of shear and normal stresses as specified by the baseline data (e.g., as observed in lab testing). Thus, the formation model can be used to suggest that formation failure can take place if a stress state of the formation at the specified strength parameters is greater than the defined failure envelope.

In some examples, for each node of the initial wellbore model, the simulator 108 can compute the stiffness matrix K^{e}. For example, the simulator 108 can compute the stiffness matrix K^{e} based on the strain-displacement matrix B, the transpose of the strain-displacement matrix B^{T} and the consistent tangent matrix D. The strain-displacement matrix B can contain derivatives of shape functions with respect to coordinate variables. The simulator 108 can compute a stress tensor σᵢⱼ for a respective node of the initial wellbore model based on the strain-displacement matrix B and the consistent tangent matrix D. The simulator 108 can compute a stress distribution that can include principal stress values for one or more nodes (e.g., point or locations) of the initial wellbore model. For example, the simulator 108 can use Eigenvalues of the computed stress tensor σᵢⱼ as described herein for the one or more nodes. The stress distribution can be evaluated relative to failure criteria 110 to determine whether the one or more nodes experienced a deformation failure during the simulation. As an example, the failure criteria 110 can include a Mohr-Coulomb criterion, a Mogi criterion, a Drucker-Prager criterion, a Lade criterion, or a different type of failure criteria.

The failure criteria 110 can be used by the simulator 108 during simulation to evaluate a stress state at each point (or node) against strength parameters assigned to said point to decide on a possibility of failure. For example, if the Mogi failure criterion is used by the simulator 108, the principle stresses calculated for the deformation model (e.g., (σ₁, σ₂, σ₃)) can be used to determine a value of an octahedral shear stress (τ). The simulator 108 can use a failure criteria function to compute for each respective point a failure criteria value based on the strength parameters assigned for a respective point and the calculated principle stress for the respective point. The simulator 108 can subtract the failure criteria value from the calculated octahedral shear stress and if a result is a positive value this can indicate that the point lies above the failure envelope, which means this point will be predicted to fail.

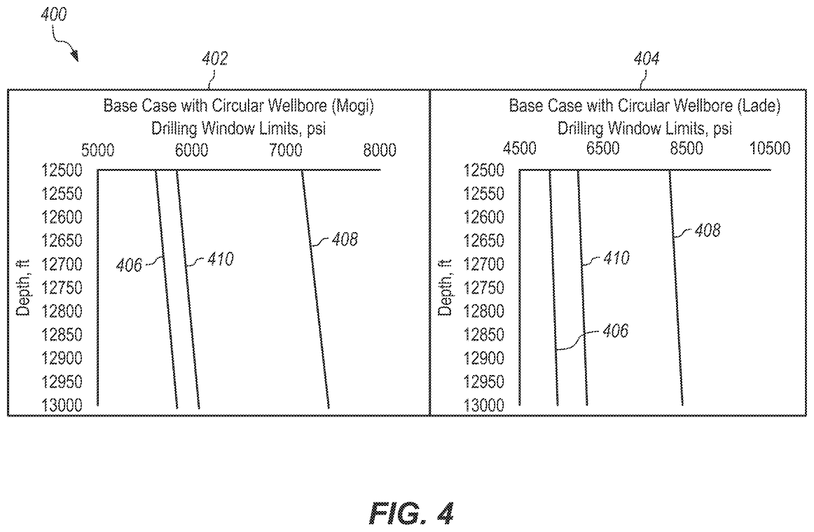

In some examples, the simulator 108 can compute a stress field distribution and use the distribution to determine failure. For example, the simulator 108 can compute a displacement according the expression (1). The simulator 108 can convert the displacement into a strain value (e.g., based on the change in the solid body dimensions). The simulator 108 can convert the strain value into a stress value (e.g., based on a constitutive model for stress-strain). Thus, by determining the stress value at all locations (nodes) in a solid body, the simulator 108 can compute the stress field distribution. The simulator 108 can use a failure criterion, for example, as described herein, to determine whether a state of stress at each location (node) will lead to a failure, or not. If the stress state in a given location in a wellbore model translates into a shear failure (e.g., according to the failure criterion, which can be Mogi, Mohr-Coulomb, or the Lade criterion), then a minimum mud weight can be defined. For example, the minimum mud weight can correspond to a minimum mud weight 406, as shown in the example of FIG. 4. In some examples, if the stress state in the given location in the wellbore model translates into a tensile failure, then a maximum mud weight can be defined. The maximum mud weight can correspond to a maximum mud weight 408, as shown in the example of FIG. 4.]

In some examples, the simulator 108 can determine or compute a mud weight and/or downhole pressure required for preventing wellbore failure for the main wellbore, which can be provided as drilling parameter data 112, as shown in FIG. 1. For example, the simulator 108 can determine the mud weight and/or downhole pressuring according to the failure criteria 110. The drilling parameter data 112 can be used to adjust operating parameters for forming the main wellbore. In some instances, the drilling parameter data 112 can be provided to a drilling fluid control system, which can control a supply of drilling fluid. The supply of the drilling fluid can be changed by drilling fluid control system using the drilling parameter data 112.

In response to the simulation, the simulator 108 can output stress field data 114 characterizing the stress field from the simulation for the main wellbore model in the formation model. Thus, the stress field data can characterize stress disturbances in the formation model only from the creation of the main wellbore model in the formation model, in some instances, referred to herein as an undisturbed stress field. The stress field data 114 can be referred to as initial stress field data 114 for the formation model, as shown in FIG. 1. Accordingly, the simulator 108 can assess an initial stress distribution for the initial wellbore model without any lateral wellbores. The stress field data 114 can include stress values for nodes of the initial wellbore model.

The stress field assessment engine 100 further includes a model updating component 116 that can update the initial wellbore model to include one or more lateral wellbore models representative of a lateral wellbore that can be formed from the main wellbore. The model updating component 116 can update the wellbore model based on lateral data 118, which can identify parameters defining the one or more lateral wellbore models, and in some instances parameters for simulating the one or more lateral wellbore models. In some examples, the model updating component 116 can re-mesh the initial wellbore model to include the one or more lateral wellbore models. The model updating component 116 can output the wellbore model with the main wellbore model and the one or more lateral wellbore models as an updated wellbore model 120, as shown in FIG. 1.

The simulator 108 can simulate stress distributions (or disturbances) that can be caused in the formation model during creation of the lateral wellbore model therein based on the updated wellbore model 120 and the initial stress field data 114. For example, the simulator 108 can determine a stress distribution in both a main mother-bore and one or more child side-track wellbores. The simulator 108 (or a different module) can be used to determine an outcome of an interaction between induced stresses from both the mother-bore and one or more child side-track wellbores according to the examples described herein. The simulator 108 can output updated stress field data 122 characterizing stress disturbances or formations in the formation model from both the main wellbore model and the lateral wellbore models. In some examples, the stress field assessment engine 100 can be configured to cause operating parameters for forming one of the main or lateral wellbore to be updated based on the updated stress field data. In further examples, simulator 108 can be configured to provide the drilling parameter data 112 for forming one of the main or lateral wellbore based on the updated stress field data 122.

Accordingly, the stress field assessment engine 100 can be used to assess rock failure in a lateral wellbore extending from a main wellbore by considering the updated or cumulative assessment of stress distribution. Even though both the main wellbore and the one or more lateral well bores are drilled in a same formation, same type of rock, within a same direction and trajectory, and using same drilling tools, a drilling experience in the one more lateral direction is distinguished through this process. To ensure that the main wellbore influence is captured accurately, the stress field assessment engine 100 can update the wellbore model while retaining the initial stress field calculations and use these calculations to compute an updated stress field for the formation. Furthermore, simulating the wellbore model using a meshing technique with a 20-node brick element and according to the examples described herein can improve a computing speed at which the wellbore model simulated according other wellbore model simulation techniques is performed.

The stress field assessment engine 100 can be implemented using one or more modules, shown in block form in the drawings in the example of FIG. 1. The one or more modules can be in software or hardware form, or a combination thereof. In some examples, the stress field assessment engine 100 can be implemented as machine readable instructions for execution on a computing device 124, as shown in FIG. 1. The computing device 124 can include any computing device, for example, a desktop computer, a server, a controller, a blade, a mobile phone, a tablet, a laptop, a personal digital assistant (PDA), and the like. The computing device 124 can include a processor 126 and a memory 128. By way of example, the memory 128 can be implemented, for example, as a non-transitory computer storage medium, such as volatile memory (e.g., random access memory), non-volatile memory (e.g., a hard disk drive, a solid-state drive, a flash memory, or the like), or a combination thereof. The processor 126 could be implemented, for example, as one or more processor cores. The memory 128 can store machine-readable instructions (e.g., which can include the stress field assessment engine 100) that can be retrieved and executed by the processor 126. Each of the processor 126 and the memory 128 can be implemented on a similar or a different computing platform. The computing platform could be implemented in a computing cloud. In such a situation, features of the computing platform could be representative of a single instance of hardware or multiple instances of hardware executing across the multiple of instances (e.g., distributed) of hardware (e.g., computers, routers, memory, processors, or a combination thereof). Alternatively, the computing platform could be implemented on a single dedicated server or workstation.

FIG. 2 is an example of a multilateral wellbore 200 in a formation 202. In the example of FIG. 2, the formation 202 can include a rock formation, and in some instances other formations. The multilateral wellbore 200 includes a main wellbore 204 (referred to as “WBO” in the example of FIG. 2), and a number of lateral wellbores 206-208 (referred to as “WB1” and “WB2” respectively in the example of FIG. 2). As shown in the example of FIG. 2, the lateral wellbores 206-208 extend from the main wellbore 204 from a lateral initiation point (or branching junction) 210 of the multilateral wellbore 200. The lateral initiation point 210 defines or identifies a point or location at which a borehole for the lateral wellbore is formed. Drilling experience shows that drilling difficulties are common at the lateral initiation point 210 due to a disturbed stress field in the formation 202 caused by the main wellbore 204. The stress field in the formation 202 is changed in the formation 202, for example, during drilling of the main wellbore 204, which can be referred to as a disturbed stress field. The lateral wellbores 206-208 are in close proximity to the main wellbore 204, which means that these portions of the lateral wellbores 206-208 are drilled in the fully disturbed stress field.

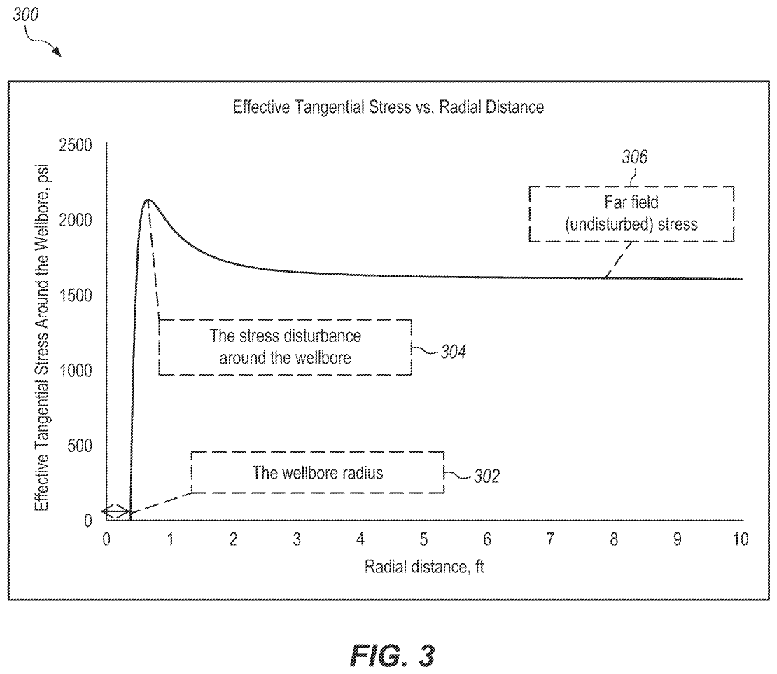

FIG. 3 is an example of a graph 300 illustrating a concentration or disturbance of stress due to a presence of a wellbore, such a main wellbore, for example, the main wellbore 204 identified as “WBO” in the example of FIG. 2. Thus, reference can be made to the example of FIGS. 1-2 in the example of FIG. 3. The graph 300 characterizes tangential stress effects on a lateral wellbore (e.g., one of the lateral wellbores 206-208, as shown in FIG. 2) caused by the main wellbore. A horizontal axis of the graph 300 represents a radial distance (in feet) of the lateral wellbore and a vertical axis of the graph 300 represents an effective tangential stress around the lateral wellbore (in pounds per square inch (PSI)). In the example of FIG. 3, for example, at 302, illustrates a radius of the lateral wellbore. For example, the radius of the lateral wellbore can between 0 to 1 feet in radial size. At 304, in the example of FIG. 3 illustrates a stress disturbance around the wellbore caused by the main wellbore. For example, the stress disturbance for the lateral wellbore from the main wellbore is greater than 2000 PSI. As the radius of the lateral wellbore increases, as shown in FIG. 3, the effective tangential stress around the lateral wellbore caused by the main wellbore decreases until reaching far-field values, as shown at 306 in the example of FIG. 3.

FIG. 4 is an example of mud weight recommendation graphs 402-404 (e.g., for a circular wellbore) of mud weight recommendations that can be provided by a simulator, such as the simulator 108, as shown in FIG. 1. Thus, reference can be made to the example of FIG. 1 in the example of FIG. 4. The mud weight recommendations, as shown in the mud weight recommendation graph 402, can be computed according to the Mogi-Coulomb failure criteria, and mud weight recommendations, as shown in the mud weight recommendation graph 404, can be computed according to the Lade/Drucker-Prager failure criteria (e.g., of the failure criteria 110, as shown in FIG. 1) by the simulator 108. A horizontal axis of each mud weight recommendation graph 402-404 can characterize drilling window limits (in PSI), and a vertical axis of each mud weight recommendation graph 402-404 can characterize a depth (in feet). Each of the mud weight recommendation graphs 402-404 includes a minimum mud weight (identified with 406 in example of FIG. 4), a maximum mud weight (identified with 408 in example of FIG. 4), and an actual mud weight (identified with 410 in example of FIG. 4). In the example of FIG. 4, the actual mud weight is an an illustration of how actual final recommendations can be generated from the simulation. The actual mud weight can correspond to a mud weight that can be selected to be used in a field based on the simulation output (e.g., the max and min mud weights).

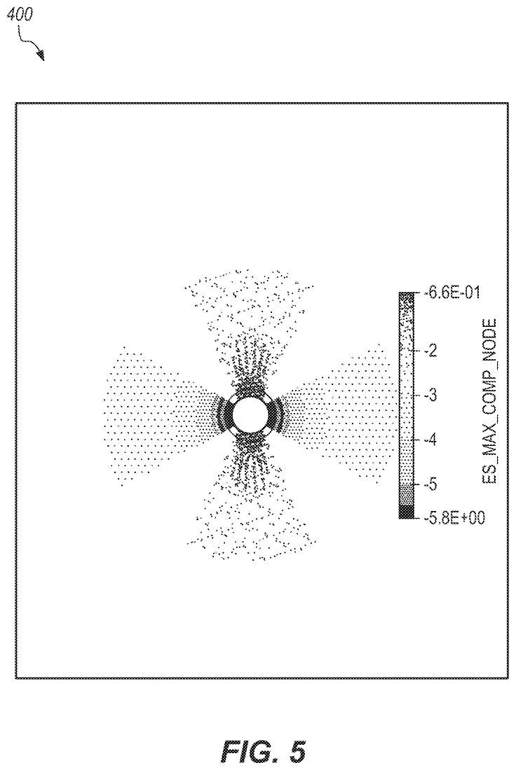

FIG. 5 is an example of a stress field 500 around a wellbore, for example, the main wellbore 204, as shown in FIG. 2. Thus, reference can be made to the examples of FIGS. 1-2 in the example of FIG. 5. According to the examples described herein, the simulator 108 can compute or determine the stress field around the wellbore in the formation model and thus an undisturbed stress field that has not been modified or changed by lateral wellbores. Thus, the stress field in the example of FIG. 5 can be representative of an initial stress disturbance that would be caused by excavation of the main wellbore in the formation. A less shaded area in the example of FIG. 5 represents undisturbed stress values in the formation, while more shaded areas represent more disturbed stress values around the main wellbore.

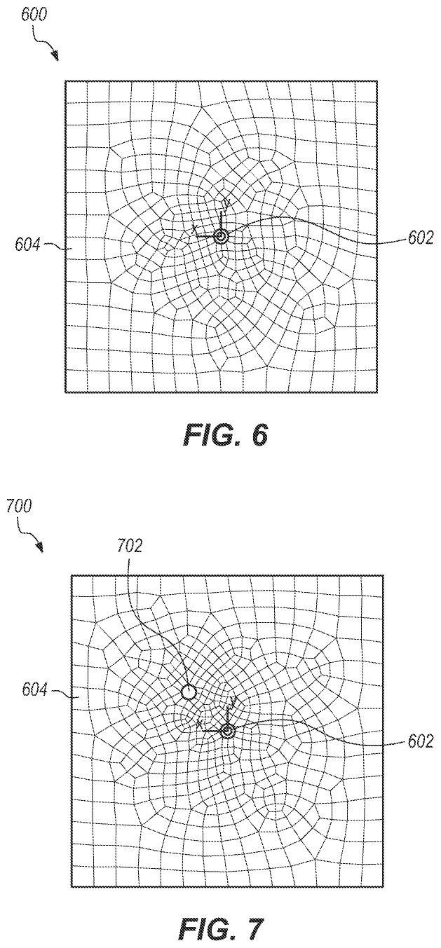

FIG. 6 is an example of wellbore model 600 representing a main wellbore model 602 penetrating a formation model 604 (e.g., subterranean rock formation). In some examples, the wellbore model 600 corresponds to the initial wellbore model, as described herein with respect to FIG. 1. Thus, reference can be made to the example of FIG. 1 in the example of FIG. 6. The wellbore model 600 can be processed by the simulator 108 to determine or compute stress fields for the wellbore model 600 resulting from a simulated formation of the main wellbore model 602 therein. The simulator 108 can output the initial stress field data 114 that can characterize the computed stress fields for the formation model 604, as shown in FIG. 6, in some instances.

FIG. 7 is an example of the wellbore model 600 updated with a lateral wellbore model 702 that penetrates the formation model 604 and is referred to herein as an updated wellbore model 700. In some examples, the updated wellbore model 700 corresponds to the updated wellbore model 120, as shown in FIG. 1. Thus, reference can be made to the example of FIGS. 1 and 6 in the example of FIG. 7. The updated wellbore model 700 can be processed by the simulator 108 to determine or compute stress fields for the wellbore model 600 resulting from a simulated formation of the lateral wellbore model 702 therein. The simulator 108 can output the updated stress field data 122 characterizing stress disturbances or formations in the formation model 604 from both the main wellbore model 602 and the lateral wellbore model 702, as shown in FIG. 7, in some instances.

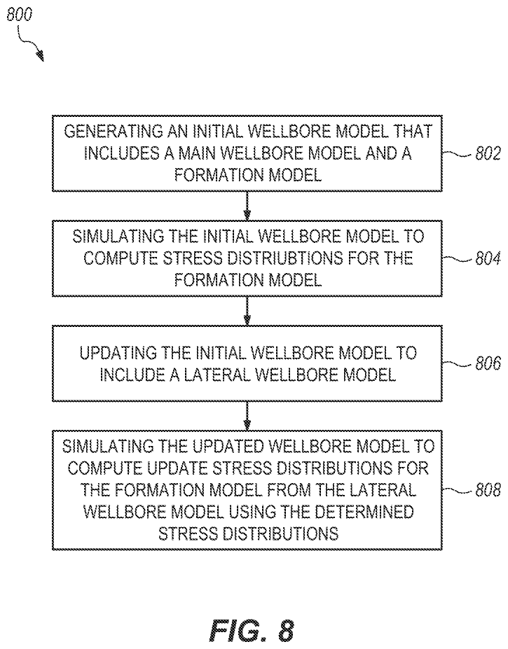

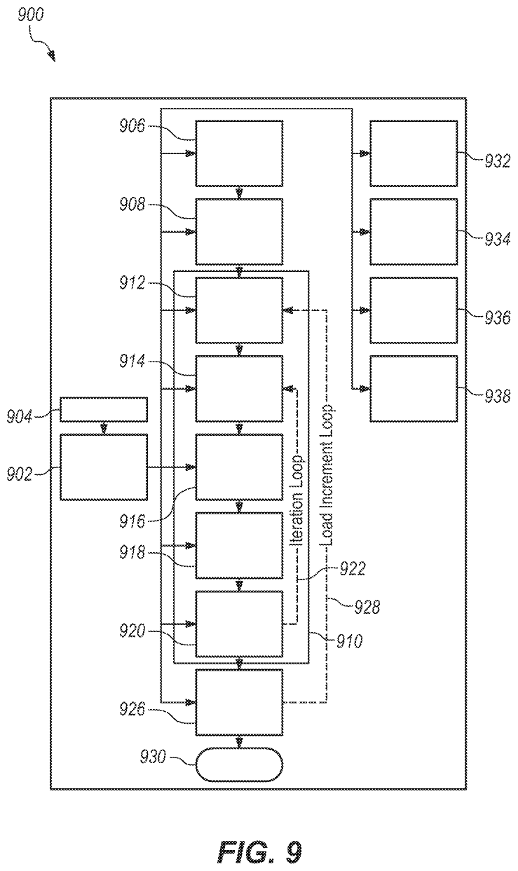

In view of the foregoing structural and functional features described above, an example method will be better appreciated with reference to FIGS. 8-9. While, for purposes of simplicity of explanation, the example methods of FIGS. 8-9 are shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement the methods.

FIG. 8 is an example of a method 800 for modeling stress disturbances in formation (e.g., the formation 202, as shown in FIG. 2). The method 800 can be implemented by the stress field assessment engine 100, as shown in FIG. 1. Thus, reference can be made to examples of FIGS. 1-2 in the example of FIG. 8. At 802 of the method 800 an initial wellbore model that includes a formation model and main wellbore model is generated (e.g., by the pre-processing component 102, as shown in FIG. 1). At 804, the initial wellbore model is simulated (e.g., by the simulator 108, as shown in FIG. 1), to compute stress distributions (corresponding to the initial stress field data 114, as shown in FIG. 1) in the formation model caused during main wellbore model formation.

At 808, the initial wellbore model is updated (e.g., by the model updating component 116, as shown in FIG. 1) to include a lateral wellbore model to provide an updated wellbore model (e.g., the updated wellbore model 120, as shown in FIG. 1). At 810, the updated wellbore model is simulated (e.g., by the simulator 108, as shown in FIG. 1) to compute updated stress distributions (corresponding to the updated stress field data 122, as shown in FIG. 1) in the formation model caused during lateral wellbore model formation using the determined stress distributions.

FIG. 9 is another example of a method 900 for modeling stress disturbances in formation (e.g., the formation 202, as shown in FIG. 2). At least some of the method 900 can be implemented by the stress field assessment engine 100, as shown in FIG. 1. Thus, reference can be made to examples of FIGS. 1-2 in the example of FIG. 9. The method 900 can be start at 902 by initiating the stress field assessment engine 100 (e.g., executing the stress field assessment engine 100 on the computing device 124, as shown in FIG. 1). In some examples, at 902, dimension control data characterizing a dimension of a main wellbore and formation can be received by the stress field assessment engine 100 for generating corresponding main wellbore and formation models, respectively.

At 906, initial values can be set to zero. For example, input variables can be reset to a predefined value to avoid carrying values from a previous iteration or run. The input variables can include, for example, geologic (earth) in situ stresses acting on a wellbore, a dimension, geometry and a placement of the wellbore within an in situ stress field, and/or mechanical properties of solid components that form the wellbore. At 908, an input file (e.g., corresponding to the parameter data 104, as shown in FIG. 1) can be received. The input file can specify load and property requirements for an initial wellbore model. In some instances, at 908, an initial wellbore model (e.g., as described with respect to FIG. 1) can be created that includes a main wellbore model and a formation model. In some instances, at 908, the initial wellbore model can be loaded into the simulator 108, as shown in FIG. 1.

At 910, the initial wellbore model can be simulated (e.g., by the simulator 108, as shown in FIG. 1) to compute stress distributions (or disturbances) that can result or be caused in the formation model by the main wellbore model based on the initial wellbore model. In some instances, at 912, a first load increment of a number of load increments can be selected for the simulation of the initial wellbore model (e.g., for one or more nodes of the model). The load increments can be specified by the input file, in some instances. At 914, a stiffness matrix representing mechanical properties of the formation and a displacement (e.g., as described herein) can be computed based on the first load increment. At 916, residual forces including a body force and a traction force can be calculated based on the first load increment.

At 918, the residual forces are evaluated relative to a tolerance value in a same or similar manner as described herein. At 920, a minimization of total energy expression (e.g., the expression (1), as described herein) is evaluated to determine whether this expression converged. The method 900 can proceed at 922 to step 914 in response to determining that the minimization of total energy expression did not converge, and the residual forces can be used in a next iteration (e.g., for other nodes). The iterations can be performed to ensure convergence. The convergence can be checked through estimating residual forces, for example, as described herein. For instance, the residual forces can be calculated to check for convergence and equilibrium by subtracting a left-hand side from a right-hand side in expression (1), where the left-hand side is a global stiffness matrix multiplied by a displacement, and the right-hand side is body and traction forces. The value obtained from the subtraction of these two quantities should be equal to zero if the equilibrium condition is fully satisfied. However, that is not always achievable, as described herein; therefore, a tolerance value can be set to check for convergence. The tolerance value can be set to be close but not equal to zero. Once the residual forces are calculated and found to be less than the set tolerance value, convergence can be said to be achieved; otherwise, the residual forces are carried to the next iteration.

In some examples, if the minimization of total energy expression did converge, at 926, data (e.g., a value of the displacement u) can be outputted indicating the convergence. The method 900 can proceed at step 928 to step 912 to select a second load increment of the load increments and the above process can be repeated. The method 900 can end at 930 after each load increment of the load increments has been evaluated.

In some examples, at 932, boundary conditions are provided as the displacement to define or identify fixed nodes of the initial wellbore model. The boundary conditions can be used to define locations (nodes) within a wellbore body where displacements are already known. This can help reduce a number of unknown variables, so that a system of linear equations that will be produced from expression (1) can be solved (e.g., by the simulator 108, as shown in FIG. 1).

In some examples, at 934, deformation data relating to loading due to pressure and temperature on the formation can be considered by the simulator during stress field computations. For example, through empirical correlations, the simulator 108 can reflect an influence of temperature on stress distribution on the wellbore body

In some examples, at 936, a partial residual plot can be outputted based on the simulation carried out by the simulation during stress field computations that can graphically represent stress fields in the formation model caused by the main wellbore model.

In some examples, at 938, a resolution index can be set for an integration solver of the simulator 108. Integrations, such as the ones described with respect to expression (1) are not solved analytically, but are solved using approximate methods by the simulator 108. By way of example, a method used here is a Gaussian quadrature. Because this method solves integrations at different resolutions (with respect to the integration function curve), this resolution can be set at step 938.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof. In addition, the use of ordinal numbers (e.g., first, second, third, etc.) is for distinction and not counting. For example, the use of “third” does not imply there must be a corresponding “first” or “second.” Also, as used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

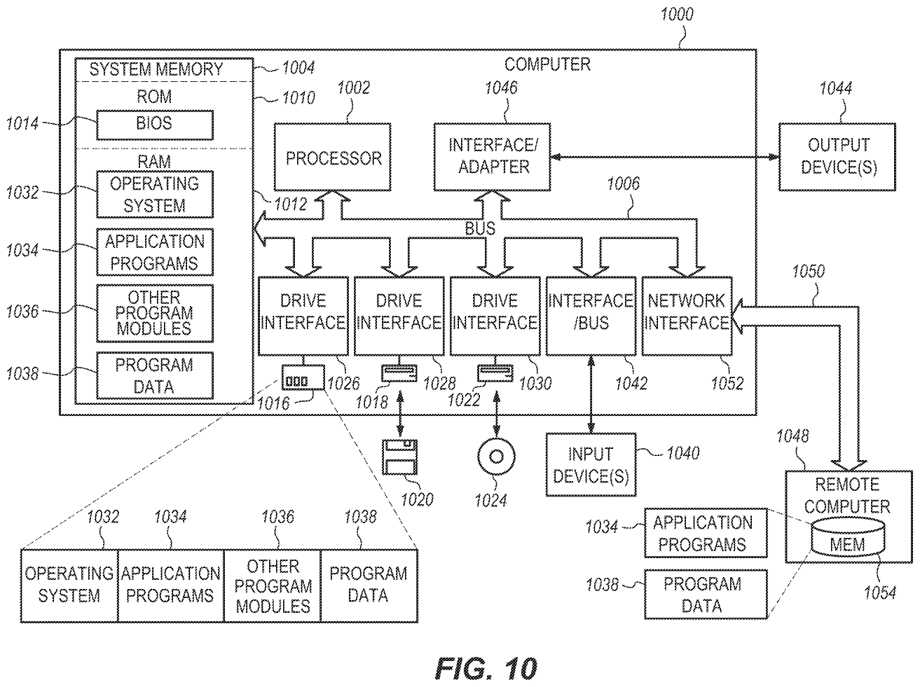

In view of the foregoing structural and functional description, those skilled in the art will appreciate that portions of the embodiments may be embodied as a method, data processing system, or computer program product. Accordingly, these portions of the present embodiments may take the form of an entirely hardware embodiment, an entirely software embodiment, or an embodiment combining software and hardware, such as shown and described with respect to the computer system of FIG. 10. Furthermore, portions of the embodiments may be a computer program product on a computer-usable storage medium having computer readable program code on the medium. Any non-transitory, tangible storage media possessing structure may be utilized including, but not limited to, static and dynamic storage devices, hard disks, optical storage devices, and magnetic storage devices, but excludes any medium that is not eligible for patent protection under 35 U.S.C. § 101 (such as a propagating electrical or electromagnetic signal per se). As an example and not by way of limitation, a computer-readable storage media may include a semiconductor-based circuit or device or other IC (such, as for example, a field-programmable gate array (FPGA) or an ASIC), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. A computer-readable non-transitory storage medium may be volatile, nonvolatile, or a combination of volatile and non-volatile, where appropriate.

Certain embodiments have also been described herein with reference to block illustrations of methods, systems, and computer program products. It will be understood that blocks of the illustrations, and combinations of blocks in the illustrations, can be implemented by computer-executable instructions. These computer-executable instructions may be provided to one or more processor of a general purpose computer, special purpose computer, or other programmable data processing apparatus (or a combination of devices and circuits) to produce a machine, such that the instructions, which execute via the processor, implement the functions specified in the block or blocks.

These computer-executable instructions may also be stored in computer-readable memory that can direct a computer or other programmable data processing apparatus to function in a particular manner, such that the instructions stored in the computer-readable memory result in an article of manufacture including instructions which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

In this regard, FIG. 10 illustrates one example of a computer system 1000 that can be employed to execute one or more embodiments of the present disclosure. Computer system 1000 can be implemented on one or more general purpose networked computer systems, embedded computer systems, routers, switches, server devices, client devices, various intermediate devices/nodes or standalone computer systems. Additionally, computer system 1000 can be implemented on various mobile clients such as, for example, a personal digital assistant (PDA), laptop computer, pager, and the like, provided it includes sufficient processing capabilities.

Computer system 1000 includes processing unit 1002, system memory 1004, and system bus 1006 that couples various system components, including the system memory 1004, to processing unit 1002. Dual microprocessors and other multi-processor architectures also can be used as processing unit 1002. System bus 1006 may be any of several types of bus structure including a memory bus or memory controller, a peripheral bus, and a local bus using any of a variety of bus architectures. System memory 1004 includes read only memory (ROM) 1010 and random access memory (RAM) 1012. A basic input/output system (BIOS) 1014 can reside in ROM 1010 containing the basic routines that help to transfer information among elements within computer system 1000.

Computer system 1000 can include a hard disk drive 1016, magnetic disk drive 1018, e.g., to read from or write to removable disk 1020, and an optical disk drive 1022, e.g., for reading CD-ROM disk 1024 or to read from or write to other optical media. Hard disk drive 1016, magnetic disk drive 1018, and optical disk drive 1022 are connected to system bus 1006 by a hard disk drive interface 1026, a magnetic disk drive interface 1028, and an optical drive interface 1030, respectively. The drives and associated computer-readable media provide nonvolatile storage of data, data structures, and computer-executable instructions for computer system 1000. Although the description of computer-readable media above refers to a hard disk, a removable magnetic disk and a CD, other types of media that are readable by a computer, such as magnetic cassettes, flash memory cards, digital video disks and the like, in a variety of forms, may also be used in the operating environment; further, any such media may contain computer-executable instructions for implementing one or more parts of embodiments shown and described herein.

A number of program modules may be stored in drives and RAM 1010, including operating system 1032, one or more application programs 1034, other program modules 1036, and program data 1038. In some examples, the application programs 1034 can include the stress field assessment engine 100, as shown in FIG. 1. The application programs 1034 can include functions and methods programmed for stress field assessment according to the examples described herein.

A user may enter commands and information into computer system 1000 through one or more input devices 1040, such as a pointing device (e.g., a mouse, touch screen), keyboard, microphone, joystick, game pad, scanner, and the like. These and other input devices are often connected to processing unit 1002 through a corresponding port interface 1042 that is coupled to the system bus, but may be connected by other interfaces, such as a parallel port, serial port, or universal serial bus (USB). One or more output devices 1044 (e.g., display, a monitor, printer, projector, or other type of displaying device) is also connected to system bus 1006 via interface 1046, such as a video adapter.

Computer system 1000 may operate in a networked environment using logical connections to one or more remote computers, such as remote computer 1048. Remote computer 1048 may be a workstation, computer system, router, peer device, or other common network node, and typically includes many or all the elements described relative to computer system 1000. The logical connections, schematically indicated at 1050, can include a local area network (LAN) and a wide area network (WAN). When used in a LAN networking environment, computer system 1000 can be connected to the local network through a network interface or adapter 1052. When used in a WAN networking environment, computer system 1000 can include a modem, or can be connected to a communications server on the LAN. The modem, which may be internal or external, can be connected to system bus 1006 via an appropriate port interface. In a networked environment, application programs 1034 or program data 1038 depicted relative to computer system 1000, or portions thereof, may be stored in a remote memory storage device 1054.

The invention claimed is:

1. A computer implemented method comprising:
generating, by one or more processors, an initial wellbore model that includes a formation model and main wellbore model;
simulating, by the one or more processors, the initial wellbore model to compute stress distributions in the formation model caused during main wellbore model formation;
updating, by the one or more processors, the initial wellbore model to include a lateral wellbore model to provide an updated wellbore model; and
simulating, by the one or more processors, the updated wellbore model to compute updated stress distributions in the formation model caused during lateral wellbore model formation using the determined stress distributions.

2. The computer implemented method of claim 1, further comprising outputting updated stress field data characterizing the updated stress disturbances in the formation model caused during the lateral wellbore model formation.

3. The computer implemented method of claim 2, further comprising causing, by the one or more processors, to update operating parameters for forming one of the main or lateral wellbore based on the updated stress field data.

4. The computer implemented method of claim 2, further comprising computing, by the one or more processors drilling parameter data for updating operating parameters for forming one of the main or lateral wellbore based on the updated stress field data.

5. The computer implemented method of claim 4, wherein simulating, by the one or more processors, the initial wellbore model to determine the stress distributions in the formation model caused during main wellbore model formation comprises:
computing a strain-displacement matrix based on a stiffness matrix and a displacement value; and
computing a stress tensor for a respective node of the initial wellbore model based on the strain-displacement matrix and a consistent tangent matrix.

6. The computer implemented method of claim 5, wherein the stress distributions in the formation model include principal stress values for the respective node of the initial wellbore model.

7. The computer implemented method of claim 4, further comprising evaluating the updated stress distributions in the formation model caused during the lateral wellbore model formation based on failure criteria to determine whether one or more nodes of the formation model experienced a deformation failure.

8. The computer implemented method of claim 4, wherein the failure criteria includes one of a Mohr-Coulomb criterion, a Mogi criterion, a Drucker-Prager criterion, and a Lade criterion.

9. A system comprising:
memory to store machine-readable instructions; and
one or more processors to access the memory and execute the machine-readable instructions, the machine-readable instructions comprising a stress field assessment engine comprising:
a pre-processing component programmed to generate an initial wellbore model that includes a formation model and main wellbore model;
a simulator programmed to simulate the initial wellbore model to compute stress distributions in the formation model caused during main wellbore model formation; and
a model updating component programmed to update the initial wellbore model to include a lateral wellbore model to provide an updated wellbore model,
wherein the simulator is further programmed to simulate the updated wellbore model to determine updated stress distributions in the formation model caused during lateral wellbore model formation using the determined stress distributions.

10. The system of claim 9, wherein the stress field assessment engine is programmed to output updated stress field data characterizing the updated stress disturbances in the formation model caused during the lateral wellbore model formation.

11. The system of claim 10, wherein the stress field assessment engine is further programmed to cause operating parameters for forming one of the main or lateral wellbore to be updated based on the updated stress field data.

12. The system of claim 10, wherein the stress field assessment engine is further programmed to compute drilling parameter data for updating operating parameters for forming one of the main or lateral wellbore based on the updated stress field data.

13. The system of claim 10, wherein the simulator is further programmed to compute
compute a strain-displacement matrix based on a stiffness matrix and a displacement value; and
compute a stress tensor for a respective node of the initial wellbore model based on the strain-displacement matrix and a consistent tangent matrix.

14. The system of claim 13, wherein the stress distributions in the formation model include principal stress values for the respective node of the initial wellbore model.

15. The system of claim 13, wherein the simulator is further programmed to evaluate the updated stress distributions in the formation model caused during the lateral wellbore model formation based on failure criteria to determine whether one or more nodes of the formation model experienced a deformation failure.
